(19) United States
(12) Patent Application Publication
(10) Pub. No.: US 2026/0159634 A1
(43) Pub. Date: Jun. 11, 2026

(54) FABRICATION OF HIGH-PERFORMANCE POLYISOCYANURATE-BASED FOAMS

(71) Applicants: UT-Battelle, LLC, Oak Ridge, TN (US); University of Utah Research Foundation, Salt Lake City, UT (US)

(72) Inventors: Som S. Shrestha, Knoxville, TN (US); Zoriana Demchuk, Knoxville, TN (US); Catalin Gainaru, Lenoir City, TN (US); Diana Hun, Lenoir City, TN (US); Shiwanka Vidarshi Wanasinghe Wanasinghe Mudiyanselage Pahala Gedara, Oak Ridge, TN (US); Tomonori Saito, Knoxville, TN (US); Achutha Tamraparni, Knoxville, TN (US); Tianli Feng, Millcreek, UT (US); Janak Tiwari, Salt Lake City, UT (US)

(21) Appl. No.: 19/414,891

(22) Filed: Dec. 10, 2025

Related U.S. Application Data
(60) Provisional application No. 63/729,986, filed on Dec. 10, 2024.

(51) Int. Cl. C08G 18/76; C08G 18/16; C08G 18/75; C08G 101/00; C08J 9/14; C08J 9/36

(52) U.S. Cl. CPC C08G 18/7621; C08G 18/163; C08G 18/758; C08G 18/7664; C08J 9/146; C08J 9/36; C08G 2101/00; C08G 2110/005

(57) ABSTRACT

A composition for fabricating a closed-cell polyisocyanurate (PIR) foam includes: approximately 20 to 45 wt. % of a polyol; approximately 40 to 70 wt. % of a polymeric isocyanate; approximately 0.1 to 1.0 wt. % of a trimerization catalyst; approximately 0.1 to 1.0 wt. % of a polyurethane catalyst; approximately 0.1 to 0.5 wt. % of a blowing catalyst; approximately 0 to 4.0 wt. % of a silicone surfactant; approximately 5 to 18 wt. % of a hydrofluoroolefin blowing agent; and approximately 0.2 to 0.5 wt. % of deionized water. A method of fabricating a closed-cell polyisocyanurate foam includes preparing the composition; transferring the composition onto a surface; and controlling expansion of the composition in one direction while allowing free expansion of the composition in a direction generally perpendicular to the said one direction, the composition curing to form a closed-cell polyisocyanurate foam having an anisotropic ratio of greater than approximately 1.5.

### CROSS-REFERENCE TO RELATED APPLICATIONS

This application claims the benefit of U.S. Provisional Application No. 63/729,986, filed Dec. 10, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of manufacturing a polyisocyanurate foam for thermal insulation and other applications, and chemical compositions for making the same.

### BACKGROUND OF THE INVENTION

High-performance insulation materials play a crucial role in enhancing cost-effectiveness, delivering significant energy cost savings, and supporting environmentally responsible practices. For example, heating and cooling of indoor spaces can account for more than half of a household's annular energy consumption. A significant reason for this high energy consumption is under-insulated commercial and residential buildings. Proper thermal insulation is vital in heating and cooling efficiency, as it can minimize heat flux by using materials with high thermal resistance. Effective insulation often results in substantial long-term energy savings due to reduced energy costs while enhancing indoor comfort. Current insulation foam boards in the marketplace have an initial thermal resistivity (R/in.) of 6.2 to 6.6 h·ft²·° F./Btu/in. which needs to be further improved to reduce heat transfer through building envelopes and to enhance energy cost savings. Therefore, a need continues to exist for insulation having improved thermal resistivity.

### SUMMARY OF THE INVENTION

A composition for fabricating a closed-cell polyisocyanurate (PIR) foam is provided. The composition includes: i) approximately 20 to 45 wt. % of a polyol; ii) approximately 40 to 70 wt. % of a polymeric isocyanate; iii) approximately 0.1 to 1.0 wt. % of a trimerization catalyst; iv) approximately 0.1 to 1.0 wt. % of a polyurethane catalyst; v) approximately 0.1 to 0.5 wt. % of a blowing catalyst; vi) approximately 0 to 4.0 wt. % of a silicone surfactant; vii) approximately 5 to 18 wt. % of a hydrofluoroolefin (HFO) blowing agent; and viii) approximately 0.2 to 0.5 wt. % of deionized (DI) water.

In specific embodiments, the polymeric isocyanate is selected from a group consisting of: i) polymeric methylene diphenyl diisocyanate (pMDI); ii) polymeric toluene diisocyanate; and iii) polymeric isophorone diisocyanate.

In specific embodiments, the hydrofluoroolefin (HFO) blowing agent is selected from a group consisting of: i) cis-1,1,1,4,4,4-hexafluoro-2-butene; ii) trans-1,3,3,3-tetrafluoropropene; iii) trans-1-chloro-3,3,3-trifluoropropene; iv) trans-1-chloro-3,3,3-trifluoropropene; and v) a combination of one or more of i) through iv) with one or more of cyclopentane, isopentane, and n-pentane.

In specific embodiments, the polyol is selected from a group consisting of: i) an aromatic polyester polyol; ii) a polyether polyol; iii) an amine-functional polyol; iv) a bio-based polyol; v) a graft polyol; and vi) a combination of two or more of i) through v).

In specific embodiments, a content of the polymeric isocyanate is in a range of from approximately 40 to 55 wt. %.

In particular embodiments, the content of the polymeric isocyanate is in a range of from approximately 50 to 55 wt. %.

In particular embodiments, the content of the polymeric isocyanate is in a range of from approximately 48 to 52 wt. %.

In specific embodiments, wherein a ratio of the polyol to the polymeric isocyanate is in a range of from approximately 0.5:1 to 1.5:1.

In specific embodiments, the composition further includes: ix) approximately 3.0 to 4.5 wt. % of a flame retardant.

A method of fabricating a closed-cell polyisocyanurate foam is also provided. The method includes preparing a composition for fabricating a closed-cell polyisocyanurate (PIR) foam according to any of the various embodiments disclosed herein. The step of preparing the composition includes: i) mixing the polyol with the trimerization catalyst, the polyurethane catalyst, the blowing catalyst, the silicone surfactant, and the deionized water to form a first mixture; ii) subsequently mixing the hydrofluoroolefin blowing agent with the first mixture to obtain a second mixture; and iii) subsequently mixing the polymeric diisocyanate with the second mixture to obtain a third mixture. The method further includes the step of transferring the third mixture onto a surface. The method further includes the step of controlling expansion of the third mixture in one direction while allowing free expansion of the third mixture in a direction generally perpendicular to the said one direction, the third mixture curing to form a closed-cell polyisocyanurate (PIR) foam having an anisotropic ratio of greater than approximately 1.5.

In specific embodiments, the one direction in which expansion is controlled is generally perpendicular to the surface.

In specific embodiments, the step of preparing the composition further includes precooling the polyol prior to mixing the polyol with the trimerization catalyst, the polyurethane catalyst, the blowing catalyst, the silicone surfactant, and the deionized water to form the first mixture.

In particular embodiments, the step of preparing the composition further includes drying the polyol prior to pre-cooling the polyol.

In specific embodiments, the step of preparing the composition further includes pre-cooling the hydrofluoroolefin blowing agent prior to mixing the hydrofluoroolefin blowing agent with the first mixture to obtain the second mixture.

In specific embodiments, the surface includes a multilayer facer, the multilayer facer including a metal layer and a polymer layer.

In particular embodiments, the polymer layer of the multilayer facer faces the third mixture.

In particular embodiments, the metal layer includes a metal foil and the polymer layer includes one or more of: a polyolefin, a polyester, a polyamide, polyethylene, polypropylene, polyethylene-vinyl alcohol copolymer, polyethylene terephthalate.

In particular embodiments, the method further includes the step of sandwiching the third mixture between a pair of the multilayer facers.

### In specific embodiments, the closed-cell polyisocyanurate foam has an R/in. value of at least 7.7

In specific embodiments, the closed-cell polyisocyanurate foam has a density less than 3.0 lb/ft³.

A closed-cell polyisocyanurate foam formed by the method is also provided.

These and other features of the invention will be more fully understood and appreciated by reference to the description of the embodiments and the drawings.

### BRIEF DESCRIPTION OF THE DRAWINGS

FIG. 1 is a flowchart of a method of fabricating a closed-cell polyisocyanurate (PIR) foam in accordance with embodiments of the disclosure;

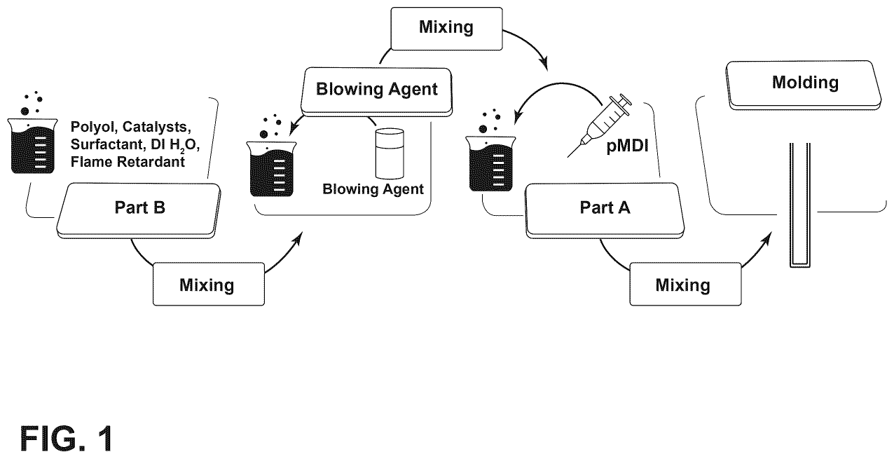

FIG. 2 is a graph of compressive strength of PIR foams formed in a vertical mold and having anisotropic cells in the direction of heat flow in accordance with embodiments of the disclosure compared with PIR foams formed in a horizontal mold and having isotropic cells;

FIG. 3 is a graph and corresponding table of thermal performance (R/in.) and density of PIR foams having various mixtures of hydrofluoroolefin (HFO1, HFO3) blowing agents in accordance with embodiments of the disclosure;

FIG. 4 is a graph of thermal performance (R/in.) of PIR foams having various pMDI content in accordance with embodiments of the disclosure;

FIG. 5 is a graph of compressive strength of the PIR foams having various pMDI content in accordance with embodiments of the disclosure;

FIG. 6 is a graph illustrating thermogravimetric analysis of the PIR foams having various pMDI content in accordance with embodiments of the disclosure in comparison to a conventional, commercial PIR foam; and

FIG. 7 is a graph of Fourier-Transform Infrared (FTIR) spectra of a PIR foam including 48% w/w pMDI in accordance with embodiments of the disclosure.

### DETAILED DESCRIPTION OF THE CURRENT EMBODIMENTS

As discussed herein, the current embodiments relate to a composition for fabricating a closed-cell polyisocyanurate (PIR) foam and a method of fabricating a closed-cell polyisocyanurate foam using the composition. The composition and method modify the cellular structure of the fabricated foam in comparison to conventional foams, thereby influencing the anisotropy of the cellular structure of the foam, enhancing retention of the blowing agent, and reducing the level of heat transfer through the foam. The composition and method thereby achieve a higher R/in. value than found in conventional PIR foams. The present composition and method also preserve the low thermal conductivity gas composition within the cellular structure of the foam, thereby minimizing aging of the initial R/in. value of the foam. The composition and each step of the associated method are separately described in detail below.

The composition for fabricating a closed-cell polyisocyanurate (PIR) foam in accordance with various embodiments of the disclosure includes: i) approximately 20 to 45 wt. % of a polyol; ii) approximately 40 to 70 wt. % of a polymeric isocyanate; iii) approximately 0.1 to 1.0 wt. % of a trimerization catalyst; iv) approximately 0.1 to 1.0 wt. % of a polyurethane (gel) catalyst; v) approximately 0.1 to 0.5 wt. % of a blowing catalyst; vi) approximately 0 to 4.0 wt. % of a silicone surfactant; vii) approximately 5 to 18 wt. % of a hydrofluoroolefin (HFO) blowing agent; and viii) approximately 0.2 to 0.5 wt. % of deionized (DI) water. The composition optionally may further include: ix) approximately 0 to 4.5 wt. % of a flame retardant, optionally between 3.0 and 4.5 wt. %. The weight percentage of each component is based on the total weight of the composition, and the sum of the weight percentages of the components for any given specific combination sum to 100%. The composition is summarized in Table 1 below.

TABLE 1
Compositions for Fabricating a Closed-
Cell Polyisocyanurate (PIR) Foam

| Component | Weight percentage (%) |
|---|---|
| Polyol | 20-45 |
| Polymeric Isocyanate | 40-70 |
| Trimerization Catalyst | 0.1-1.0 |
| Polyurethane (Gel) Catalyst | 0.1-1.0 |
| Blowing catalyst | 0.1-0.5 |
| Silicone Surfactant | 0-4.0 |
| Blowing Agent | 5-18 |
| Deionized Water | 0.2-0.5 |
| Fire Retardant | 0-4.5 |

The polymeric isocyanate may be any aromatic or aliphatic polymeric isocyanate. In various embodiments, the polymeric isocyanate may be polymeric methylene diphenyl diisocyanate (pMDI), polymeric toluene diisocyanate, polymeric isophorone diisocyanate, or a combination thereof. In certain embodiments, the polymeric isocyanate is polymeric methylene diphenyl diisocyanate (pMDI).

In certain embodiments, the content of the polymeric isocyanate is in a range of from approximately 40 to 55 wt. %. In yet other certain embodiments, the content of the polymeric isocyanate is in a range of from approximately 50 to 55 wt. %. In yet other certain embodiments, the content of the polymeric isocyanate is in a range of from approximately 48 to 52 wt. %.

In various embodiments, the polyol may be an aromatic polyester polyol, a polyether polyol, an amine-functional polyol, a bio-based polyol, a graft polyol, or a combination thereof. In certain embodiments, the polyol is an aromatic polyester polyol.

In certain embodiments, the ratio of the polyol to the polymeric isocyanate is in a range of from approximately 0.3:1 to 0.8:1. In yet other certain embodiments, the ratio is in a range of from approximately 0.55:1 to 0.8:1, alternatively of from approximately 0.55:1 to 0.6:1, alternatively of from approximately 0.58:1 to 0.8:1.

The hydrofluoroolefin (HFO) blowing agent is not particularly limited and may be any hydrofluoroolefin blowing agent. In various embodiments, the hydrofluoroolefin blowing agent is a cis-1,1,1,4,4,4-hexafluoro-2-butene (such as Opteon™ 1100), a trans-1,3,3,3-tetrafluoropropene (such as Opteon™ 1150), a trans-1-chloro-3,3,3-trifluoropropene (such as 1233zd(E)), a trans-1-chloro-3,3,3-trifluoropropene (such as Solstice® LBA), or a combination thereof. In some embodiments, the hydrofluoroolefin blowing agent is a mixture of two of the above hydrofluoroolefin blowing agents, such as, for example, a mixture of cis-1,1,1,4,4,4-hexafluoro-2-butene and trans-1,3,3,3-tetrafluoropropene. The ratio of the two hydrofluoroolefin blowing agents may be, for example, approximately 80:20, approximately 60:40, approximately 50:50, approximately 40:60, or approximately 20:80. In other embodiments, the blowing agent includes a combination of one or more of the hydrofluoroolefin blowing agents with one or more pentanes such as cyclopentane, isopentane, and/or n-pentane.

The trimerization catalyst is not particularly limited and may be any suitable trimerization catalyst. In various embodiments, the trimerization catalyst may be, for example, an alkali metal carboxylate such as potassium acetate, potassium octoate, sodium benzoate, or lithium neodecanoate; an ammonium salt such as dimethylaminoethyl ammonium formate; or a phosphonium salt such as tetrabutylphosphonium chloride. In some embodiments, the trimerization catalyst may be a combination of two or more of these catalysts.

The polyurethane (gel) catalyst is not particularly limited and may be any suitable polyurethane catalyst. In various embodiments, the polyurethane catalyst may be, for example, an amine-based catalyst such as dimethylcyclohexylamine; a metal-based catalyst such as bismuth neodecanoate; or a mixture of amine and metal-based catalysts.

The blowing catalyst is not particularly limited and may be any suitable blowing catalyst. In various embodiments, the blowing catalyst may be, for example, an amine catalyst such as pentamethyldiethylenetriamine, bis(dimethylaminoethyl) ether, N,N-dimethylcyclohexylamine, or a combination of two or more amine catalysts.

The silicone surfactant is not particularly limited and may be any suitable silicone surfactant, such as, for example, silicone polyethers or a copolymer of polydimethylsiloxane such as a copolymer of polydimethylsiloxane and polyethylene oxide-co-propylene oxide.

The flame retardant is not particularly limited and may be any suitable flame retardant. In various embodiments, the flame retardant may be, for example, an organophosphate such as tris(1,3-dichloro-2-propyl) phosphate, dimethyl methylphosphonate, or triethyl phosphate; an inorganic phosphate such as ammonium polyphosphate; a hydroxide such as an aluminum hydroxide or a magnesium hydroxide; or a combination thereof.

The method of fabricating a closed-cell polyisocyanurate foam using a composition as described above first includes preparing the composition. In various embodiments, the step of preparing the composition first includes mixing the polyol (Part B) with the trimerization catalyst, the polyurethane (gel) catalyst, the blowing catalyst, the silicone surfactant, and the deionized water to form a first mixture. In some embodiments, the polyol is pre-cooled prior to mixing with the other components. The precooling may be performed at a temperature that is less than 0° C., such as approximately −2° C. The precooling also may be performed for a time period of at least approximately 6 hours, optionally at least approximately 7 hours, optionally at least approximately 8 hours, optionally at least approximately 9 hours, optionally at least approximately 10 hours, optionally at least approximately 11 hours, optionally at least approximately 12 hours. In certain embodiments, the polyol is dried prior to being pre-cooled. The drying may be performed under vacuum, and may be performed at a temperature of at least approximately 70° C., optionally at least approximately 75° C., optionally at least approximately 80° C., optionally between approximately 70° C. and 80° C. The drying may be performed for a time period of at least approximately 6 hours, optionally at least approximately 7 hours, optionally at least approximately 8 hours, optionally at least approximately 9 hours, optionally at least approximately 10 hours, optionally at least approximately 11 hours, optionally at least approximately 12 hours. In specific embodiments, the first mixture may be stirred at a speed of approximately 400 to 800 rpm, optionally at a speed of approximately 400 to 600 rpm, optionally at a speed of approximately 450 to 550 rpm, optionally at a speed of approximately 500 to 800 rpm, optionally at a speed of approximately 600 to 800 rpm, optionally at a speed of approximately 700 to 800 rpm, optionally at a speed of approximately 500 to 700 rpm, optionally at a speed of approximately 500 to 600 rpm. In certain embodiments, the first mixture may be stirred at a speed of approximately 500 rpm. In specific embodiments, the first mixture is stirred for up to approximately 5 minutes, optionally up to approximately 4.5 minutes, optionally up to approximately 4 minutes, optionally up to approximately 3.5 minutes, optionally up to approximately 3 minutes, optionally at least approximately 2 minutes, optionally at least approximately 2.5 minutes, optionally at least approximately 3 minutes. In certain embodiments, the first mixture is stirred for approximately 3 to 4 minutes.

In various embodiments, the step of preparing the composition next includes mixing the hydrofluoroolefin blowing agent with the first mixture to obtain a second mixture. In some embodiments, the hydrofluoroolefin blowing agent is pre-cooled prior to mixing with the first mixture. The precooling may be performed at a temperature that is less than 0° C., such as approximately −2° C. The precooling also may be performed for a time period of at least approximately 6 hours, optionally at least approximately 7 hours, optionally at least approximately 8 hours, optionally at least approximately 9 hours, optionally at least approximately 10 hours, optionally at least approximately 11 hours, optionally at least approximately 12 hours. In specific embodiments, the second mixture may be stirred at a speed of approximately 400 to 500 rpm, optionally at a speed of approximately 420 to 500 rpm, optionally at a speed of approximately 440 to 500 rpm, optionally at a speed of approximately 460 to 500 rpm, optionally at a speed of approximately 480 to 500 rpm, optionally at a speed of approximately 425 to 475 rpm. In certain embodiments, the second mixture may be stirred at a speed of approximately 500 rpm. In specific embodiments, the second mixture is stirred for up to approximately 15 seconds, optionally for up to approximately 16 seconds, optionally for up to approximately 17 seconds, optionally for at least approximately 12 seconds, optionally for at least approximately 13 seconds, optionally for at least approximately 14 seconds. In certain embodiments, the second mixture is stirred for approximately 14 to 16 seconds.

In various embodiments, the step of preparing the composition next includes mixing the polymeric diisocyanate (Part A) with the second mixture to obtain a third mixture. In specific embodiments, the third mixture may be stirred at a speed of approximately 400 to 500 rpm, optionally at a speed of approximately 1000 to 2000 rpm, optionally at a speed of approximately 1100 to 2000 rpm, optionally at a speed of approximately 1200 to 2000 rpm, optionally at a speed of approximately 1300 to 2000 rpm, optionally at a speed of approximately 1400 to 2000 rpm, optionally at a speed of approximately 1500 to 2000 rpm, optionally at a speed of approximately 1600 to 2000 rpm, optionally at a speed of approximately 1700 to 2000 rpm, optionally at a speed of approximately 1800 to 2000 rpm, optionally at a speed of approximately 1900 to 2000 rpm. In certain embodiments, the third mixture may be stirred at a speed of approximately 2000 rpm. In specific embodiments, the third mixture is stirred for up to approximately 9 seconds, optionally for up to approximately 10 seconds, optionally for up to approximately 11 seconds, optionally for up to approximately 12 seconds, optionally for at least approximately 7 seconds, optionally for at least approximately 8 seconds, optionally for at least approximately 9 seconds. In certain embodiments, the third mixture is stirred for approximately 9 to 10 seconds.

After the composition is prepared as described above, the method next includes transferring the prepared composition onto a surface. Preferably, the prepared composition is transferred quickly, e.g. without delay, after completion of the preparation of the composition, i.e. after mixing/stirring the third mixture. In various embodiments, the surface may be a horizontal surface such as stationary/static planar base or a moving conveyor such as a continuous conveyor belt. In other various embodiments, the surface may be an inner surface of a mold, such as an inner surface of a vertical mold that is only open at an upper end and that has a height and length that are both greater than its width, the width being, for example between approximately 0.5 to 4 inches, optionally between approximately 0.5 to 3 inches, optionally between approximately 0.5 to 2 inches, optionally between approximately 0.5 to 1.5 inches, optionally between approximately 0.5 to 1 inch. It should be understood, however, that such a mold could be placed on its side so that the opening faces laterally, so long as the mold has one dimension orthogonal to the opening that is narrow in comparison to the other dimensions.

After transferring the composition onto the surface, the method further includes controlling expansion of the transferred composition in one direction while allowing free expansion of the transferred composition in a direction generally perpendicular to the one direction while the transferred composition cures, in order to form a closed-cell polyisocyanurate (PIR) foam having an anisotropic ratio of greater than approximately 1.5, optionally greater than approximately 2.0, optionally greater than approximately 2.5, optionally greater than approximately 3.0, optionally greater than approximately 3.5, optionally between approximately 1.5 and 4.0, optionally between approximately 2.0 and 4.0, optionally between approximately 2.5 and 4.0, optionally between approximately 3.0 and 4.0, optionally between approximately 3.5 and 4.0, optionally between approximately 3.5 and 3.8, optionally approximately 3.8. For example, in the embodiments in which the composition is transferred onto a horizontal surface (i.e., x-y plane), the expansion may be controlled in the vertical direction (z-direction) by adjusting a horizontal planar control plate above the static base or moving conveyor and the transferred composition, such as, for example moving the control plate a close distance from the static base or moving conveyor, so that a gap between the control plate and static base or moving conveyor is for example between approximately 0.5 to 4 inches, optionally between approximately 0.5 to 3 inches, optionally between approximately 0.5 to 2 inches, optionally between approximately 0.5 to 1.5 inches, optionally between approximately 0.5 to 1 inch, optionally between approximately 1 to 4 inches, optionally between approximately 1.5 to 4 inches, optionally between approximately 2 to 4 inches, optionally between approximately 2.5 to 4 inches, optionally between approximately 3.0 to 4 inches, optionally between approximately 1 to 3 inches. In this manner, the expansion of the composition that is transferred onto the static base or moving conveyor is controlled in the vertical direction which is perpendicular to the static base or moving conveyor. At the same time, the composition is allowed to freely expand in at least one direction that is perpendicular to the controlled direction (e.g., z-direction), namely the composition is allowed to freely expand in the x- and/or y-directions. By way of example, the conveyor belt may be 4 feet wide, and the control plate may also be 4 feet wide. Further the control plate may have a square shape and thus have a length that is also 4 feet, or could alternatively be a square having a length that is different than the width. In any event, the width of the control plate generally should be the same as the width of the conveyor belt or other horizontal surface onto which the composition is transferred. After transfer of the composition onto the conveyor belt or other horizontal surface, the control plate is moved towards the conveyor belt onto which the composition has been transferred so that a narrow gap of, for example, approximately 0.5 to 4 inches is formed between the conveyor belt and the control plate with the composition therebetween. The control plate restricts expansion of the composition in the vertical direction from the conveyor belt towards the control plate, but allows the composition to freely expand transversely in directions orthogonal to the vertical direction.

Alternatively, in the case that the composition is transferred into a mold, the mold has two parallel sides with one side surface as the surface onto which the composition is transferred and the other side surface serving to control expansion of the composition in a direction from the one side surface to the other side surface. Thus, expansion of the composition is restricted in this direction but not so restricted in directions transverse to this direction. As such, the mold may be referred to, for example, as a sandwich mold, in which two sides of the mold sandwich the composition therebetween in a direction extending between the two sides.

In some embodiments, the surface onto which the composition is transferred may include a multilayer facer. The multilayer facer serves as a physical barrier to water vapor and gas molecules such as oxygen, carbon dioxide, and nitrogen. The multilayer facer also minimizes, restricts, or otherwise prevents against outward diffusion of the blowing agent and inward diffusion of air. The multilayer facer may include a metal layer and a polymer layer, with the multilayer facer being disposed on the surface so that the polymer layer of the multilayer facer is arranged to face the composition so that the composition is transferred onto the polymer layer. The metal layer may comprise a metal foil made of, for example, aluminum, copper, nickel, chromium, titanium, or a combination thereof. The polymer layer may comprise a polyolefin, a polyester, a polyamide, polyethylene, polypropylene, polyethylene-vinyl alcohol copolymer, polyethylene terephthalate, or a combination thereof. In certain embodiments, the composition may be sandwiched between a pair of the multilayer facers. For example, in the case that the transfer surface includes a conveyor belt, one multilayer facer may be placed on the conveyor belt with the metal layer facing the conveyor and the polymer layer facing in the opposite direction. The composition may then be transferred onto the polymer layer of the multilayer facer. Another multilayer facer may be disposed on the surface of the control plate with the metal layer facing the control plate and the polymer layer facing in the opposite direction towards the composition that is on the conveyor belt. Movement of the control plate towards the conveyor belt may sandwich the composition between the two polymer layers of the two multilayer facers on the conveyor belt and control plate.

A closed-cell polyisocyanurate foam formed by the method according to any of the embodiments described above may have an R/in. value of at least 7.7, optionally of at least 8.0, optionally of at least 8.3, optionally of approximately 7.8, optionally of approximately 7.9, optionally of approximately 8.0, optionally of approximately 8.1, optionally of approximately 8.2, optionally of approximately 8.3. The closed-cell polyisocyanurate foam also may have density less than 3.0 lb/ft³, optionally less than 2.9 lb/ft³, optionally less than 2.8 lb/ft³, optionally less than 2.7 lb/ft³, optionally less than 2.6 lb/ft³, optionally less than 2.5 lb/ft³, optionally in a range of from 2.5 to 3.0 lb/ft³.

### EXAMPLES

The present method is further described in connection with the following laboratory examples, which are intended to be non-limiting.

TABLE 2
Chemical Composition Used to Make Polyisocyanurate Foams

| Component | Weight percentage (%) |
|---|---|
| pMDI - Part A | 40-70 |
| Polyol - Part B | 20-45 |
| Trimerization Catalyst | 0.5-0.8 |
| Gel Catalyst | 0.1-0.3 |
| Blowing catalyst | 0.1-0.3 |
| Surfactant | 0-2.0 |
| Fire Retardant | 0-4.5 |
| Blowing Agent | 10-15 |
| Deionized Water | 0.2-0.5 |

The two main components, polyol PS2352 and polymeric methylene diphenyl diisocyanate (pMDI), were obtained from GAF Materials/Stepan Company and BASF, respectively. The polyurethane catalyst, blowing catalyst, and silicon surfactant (TEGOSTAB B8513) were obtained from Evonik Industries. The trimerization catalyst was obtained from Milliken & Company. The fire-retardant agent tris(chloroisopropyl) phosphate (TCPP) was obtained from Ambeed. The blowing agents, Opteon 1100 and Opteon 1150, were obtained from The Chemours Company.

Polyol and the blowing agent were cooled to −2° C. overnight before the reaction was initiated for all samples, except in certain circumstances specifically discussed below. This precooling step provided additional time for the components to mix homogeneously before the chemical reaction began. Part B was mixed at 500 rpm for 3 minutes using an overhead mixer, followed by the addition of the blowing agent and further mixing at 500 rpm for 15 seconds. After pMDI was added, the mixture was stirred at 2,000 rpm for 10 seconds to ensure thorough blending of Parts A and B.

To simulate controlling of the expansion of the mixture in one direction while allowing free expansion in at least one other direction, the final mixture was quickly poured into a vertical mold constructed using two pieces of plexiglass secured to a wooden frame. The vertical mold was open on the top, had a height of 12 inches, a length of 12 inches, and a gap between the two pieces of plexiglass of 1 inch. In samples requiring facer films, the inner surfaces (facing the gap) of the plexiglass pieces were covered with a facer film. Otherwise, aluminum foil was used to prevent the foam from sticking on the plexiglass. The foam mixture was allowed to cure in the mold for 24 hours before testing for thermal conductivity.

For comparative examples, the final mixture was instead transferred to a horizontal cardboard mold which was a cardboard box having a length and width of 12 inches and an opening on top of the same dimensions. The foam mixture was also allowed to cure for 24 hours prior to testing.

Thus, for both the examples and comparative examples, the PIR foams were prepared by mixing two main components (Part A and Part B) in the presence of additives. Several reactions (including a gel reaction, a blow reaction, and a trimerization reaction) take place during the formation of polyurethane and PIR, and catalysts are necessary for these processes. The present formulation was composed of three major catalysts: a trimerization catalyst, a blowing catalyst, and a gel catalyst. Surfactants were added to stabilize the foam, and a fire retardant (TCPP) was included to improve the fire resistance. The polyol was first mixed with the additives, followed by the addition of the blowing agent, after which pMDI was incorporated into the mixture. Two parts were mixed at a high rpm for a few seconds to obtain a uniform, high-quality PIR foam by ensuring efficient bubble formation, improved reaction kinetics, and a finer cellular structure (increased number of nucleating sites).

Thermal conductivity was measured in a heat flow meter apparatus at 24° C. (75° F.), following the ASTM International (ASTM) C518 standard. The sample size was 8 to 12 inches in width and length, with a thickness of 1 inch. The densities of the foams were calculated by using the ratio of mass to volume. Two equilibrium criteria were used for the thermal conductivity measurements: (1) the average temperature of each HFM plate within the measurements must remain within +0.2° C. of the set point temperature, and (2) the difference in the average signals of the heat flux transducers between two successive measurements must be within 40 V and 2%. Data points for each sample were analyzed for an average of five measurements using HFM. Additionally, 2 to 3 replicates were used for each specimen to calculate the error in measurement.

Thermogravimetric Analysis (TGA) measurements were performed using a TA Q550 under a nitrogen atmosphere. Foam samples of 1-5 mg were placed on TGA high-temperature platinum pans and measured using an analytical balance. The samples were tested in a temperature ramp regime from 25 to 700° C. with a constant heating rate of 10° C./min. A single run was conducted due to logistical constraints associated with the instrument.

Density is a crucial parameter that directly influences the thermal resistivity of the PIR foams. Lower-density foams are desirable because they have more porosity and consume fewer raw materials, making them more cost-effective compared to high-density foams. Adjusting the water content in the formulation is one way of tuning the density of foams. During initial studies, drying polyol under vacuum overnight was found to considerably increase the R/in. value of the foams by 7%, which could be the result of the removal of excess bonded water and low-volatile compounds. This observation was further supported by thermogravimetric analysis (TGA), which indicated a 5% reduction in water content after drying. Table 3 illustrates the thermal conductivities and densities of samples with different water contents (Samples A-C). To keep expansion at the same level, cyclopentane (thermal conductivity of approximately 11.6 mW·m⁻¹·K⁻¹) was used as a blowing agent (Sample D) to compensate for the removal of water from the formulation. In addition, a sample with a mixture of blowing agents (Sample E) that have similar thermal conductivities was synthesized to provide different blowing abilities. Opteon 1100 (33.4° C. [1 atm], thermal conductivity 10.4 mW·m⁻¹·K⁻¹ at 20° C.) and Solstice liquid blowing agent (19° C. [1 atm], thermal conductivity 10.2 mW·m⁻¹·K⁻¹ at 20° C.) have different boiling points, which were presumed to influence the blowing abilities.

TABLE 3
Effects of Water and Blowing Agent Quantities on the Thermal
Performance of the Polyisocyanurate Rigid Foam^{a}

| Parameter^{b} | A | B | C | D | E |
|---|---|---|---|---|---|
| Water Content w/w (%) | — | 0.1 | 0.2 | — | 0.2 |
| Opteon 1100 w/w (%) | 9.0 | 9.0 | 9.0 | — | 6.9 |
| Solstice Liquid Blowing Agent w/w (%) | — | — | — | — | 2.2 |
| Cyclopentane w/w (%) | — | — | — | 9.0 | — |
| R/in. value | 6.0 | 6.5 | 6.5 | 5.6 | 6.4 |
| Density (lb/ft³) | 3.3 | 2.6 | 2.4 | 1.7 | 2.3 |

^{a}Sample dimensions were 8 × 8 × 1 in. (203 × 203 × 25.4 mm). Thermal conductivity was measured in a heat flow meter apparatus according to ASTM C518 standards. The polyol was placed under vacuum at 75° C. overnight. The R/in. value was determined based on the average of two samples with a difference of less than 4%.
^{b}w/w = weight per weight.

To study the impact of water content, samples prepared under identical conditions and using the same blowing agent were considered (samples A, B, and C). The sample with 0.2% w/w of water (Sample C) exhibited the lowest density, showing a 27% reduction, and also demonstrated an 8% increase in the R/in. value compared with that of the control sample without water (Sample A). This improvement in R/in. value can be attributed to the enhanced expansion, confirmed by the corresponding decrease in density. In the initial nucleation process, water acts as a chemical blowing agent, reacting with isocyanate and producing CO₂. These results show that the foam density can be adjusted by modifying the water content while maintaining or even improving the R/in. value. In addition, the results demonstrated that the presence of cyclopentane considerably decreased the density by approximately 49% compared to the control sample (A); however, the R/in. value also decreased by 7%, which may have been affected by the higher thermal conductivity of cyclopentane (Sample D). The notable reduction in the density of cyclopentane may be attributed to its lower solubility in the polyol used for foam preparation, especially when compared with the solubility characteristics between Solstice and polyol. Solubility is a critical parameter, as it is well established that the density of foams produced with cyclopentane significantly varies in accordance with the solubility index. Foams with a mixture of blowing agents (Sample E) showed similar R/in. and densities compared with those of the samples with a single blowing agent (i.e., 100% Opteon 1100, Sample C). Therefore, the formulation with Opteon 1100 (Sample C) was chosen for further experiments to examine the effect of the mold design as discussed below.

Preserving the blowing agent in the reaction mixture during foam fabrication is essential to achieving higher thermal resistivity. To explore the influence of mold design in the thermal performance of PIR foams, samples were prepared using two distinct mold types as described above: vertical and horizontal. The vertical mold provided a physical barrier whereas the horizontal mold did not. The foams prepared using the vertical mold showed a significant 16% improvement in the R/in. of PIR foams, yielding an R-7.8/in., whereas the PIR foams prepared using the horizontal mold yielded an R-6.7/in. Replicate studies demonstrated the reproducibility of the findings, validating their consistency across different trials, with a difference of less than 0.5% compared to the listed R/in. (sample size 2-3). The results showed that the density of foams produced using the vertical mold increased by approximately 40% (to 2.9 lb/ft³) compared with that of the horizontal mold foams (2.1 lb/ft³), illustrating the combined effects of restricted expansion and higher retention of the blowing agents within the foam. Gas pycnometry experiments were also conducted to analyze the open and closed-cell fractions in the foam using micrometrics (Accupyc 111340) following the ASTM D-6226-15 standard. The sample size was 1×1×1 in. (25.4×25.4×25.4 mm). The samples were sealed in a 100 cm³ instrument sample chamber, and the measurements were performed at room temperature by using nitrogen gas at an equilibration rate of 0.005 psig/min. Two replicates were performed by averaging over 10 measurement cycles, with a standard deviation of less than 2% of the measured values for all measurements. Aligned with the thermal insulation performance, vertical molded samples showed a slightly higher closed-cell content (89%) compared with the foams prepared using a horizontal mold (84%).

Moreover, the geometry of the mold can influence the cell structure, which may affect thermal pathways within the foam and its thermal resistance. To investigate this effect, Scanning Electron Microscopy (SEM) analysis was performed on the samples prepared by using both the horizontal and vertical molds. SEM analysis was performed by first cutting samples into thin slices by using a sharp razor blade. The thin slices were then mounted onto SEM stubs by using double-sided carbon tape. The morphological characteristics of foams were analyzed using SEM (Hitachi S4800) at an accelerating voltage of 20 kV, with magnifications ranging from 30 to 800,000×. Two samples were tested to assess consistency, and the results demonstrated a similar outcome. The pore structures were particularly analyzed along and perpendicular to the direction of heat transfer. For the foam prepared by using the horizontal mold, the pore size along all three axes is nearly equal, indicating that the foam prepared by using a horizontal mold is nearly isotropic. In contrast, the foam prepared with the vertical mold (Pore size (D): D_{y}>>Dₓ in the plane perpendicular to the heat flow direction while D_{y}≈Dₓ in the plane along the heat flow direction) exhibited prolate pore geometry with high anisotropy (anisotropic ratio of 3.8). The more confined geometry along the X and Y directions in the vertical mold, relative to the Z direction, explains the formation of the anisotropic pore geometry. This anisotropic pore geometry distorts the heat transfer path, forcing heat flow to take longer and more tortuous paths, which reduces thermal conduction through the solid walls of porous foam. This pronounced anisotropy plays a crucial role in reducing solid thermal conductivity as it modifies the pathways through which heat can flow. The distortion of heat flow caused by the elongated cell structure creates barriers that impede the transfer of thermal energy, ultimately leading to a decrease in the overall thermal conductivity. The higher R-7.8/in. observed for the samples produced using the vertical mold, compared with R-6.7/in. for the samples produced using the horizontal mold, can be attributed to the combined effects of higher closed-cell content and anisotropic pore geometry obtained via the vertical mold.

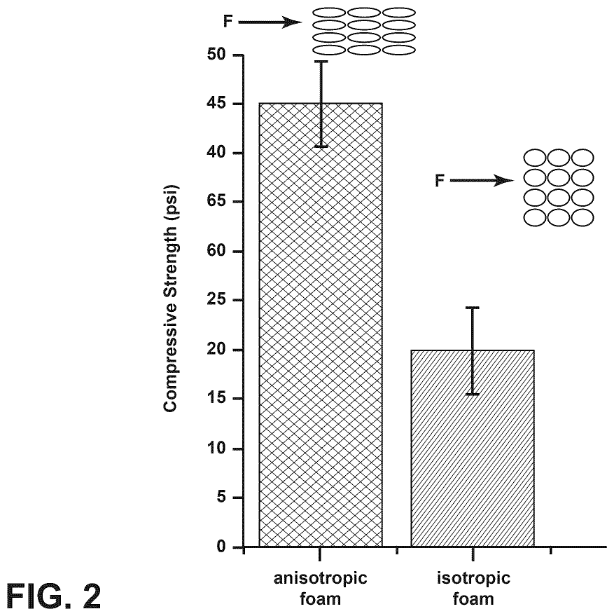

In addition to their superior thermal insulation properties, anisotropic cellular insulating materials exhibit a significantly higher compressive strength along the anisotropic axis compared with that along the transverse direction. Compressive strength tests were conducted using an Instron machine equipped with a 1 kN load cell at a 2.5 mm/min strain rate until samples reached 13% deformation or yield, whichever occurred first. Three to five samples measuring 1×1×1 in. (0.08×0.08×0.08 ft) were tested to obtain the standard deviation. The compressive strength of the PIR foams prepared using the vertical mold (anisotropic pore geometry) was strongly affected by the cell structure compared with that of the foams prepared with the horizontal mold (nearly isotropic pore geometry). As shown in FIG. 2, the vertically molded samples exhibited a 125% increase in compressive strength compared to the foams prepared using the horizontal mold (nearly isotropic foam).

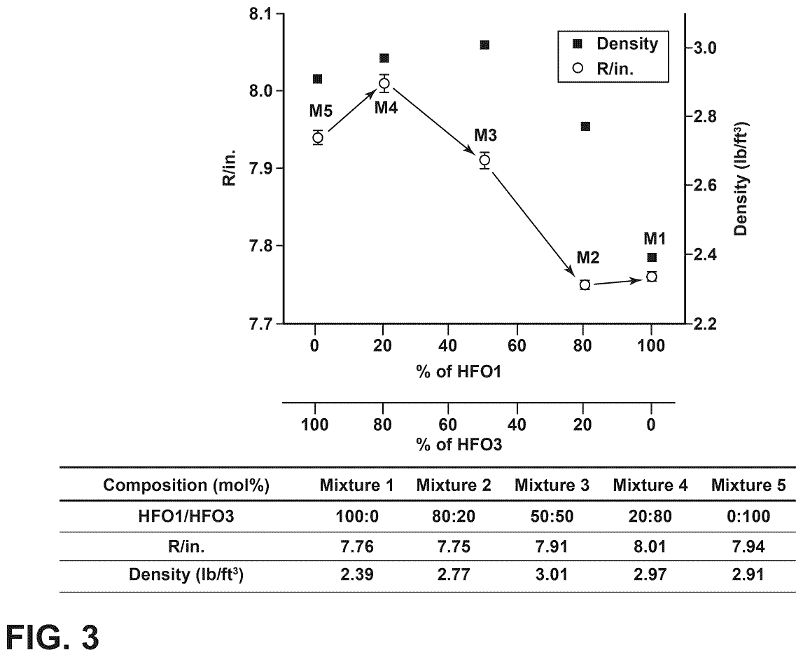

To further test the thermal insulation performance of PIR foams, Opteon 1150 was introduced to the foam composition mixture. Opteon 1150 (HFO 3) has an exceptionally low boiling point (7.5° C.) that is below room temperature, and that is significantly lower than that of Opteon 1100 (HFO 1) (33° C.). Thermal resistivities and densities of the resulting foam at various levels of Opteon 1100 and Opteon 1150 are shown in FIG. 3. The R/in. value remained largely unchanged between Mixture 1 (M1) and Mixture 2 (M2), indicating that the ratio remained consistently stable for both mixtures despite variations in the composition. However, a 15% increase in density was observed in the presence of 20% (w/w) Opteon 1150 in Mixture 2 (M2) compared with the density of Mixture 1 (M1) without Opteon 1150. This change in density confirmed that the expansion ability changed when the blend composition was modified. Further addition of Opteon 1150 to the mixtures increased the R/in. value by 2% in Mixture 3 (M3) over that of Mixture 2 (M2). However, the R/in. value remained stable with a variation of less than 2% among Mixtures 3, 4, and 5 (M3, M4, M5). Also, Mixture 5 (M5) with 100% Opteon 1150 showed an R/in. value relatively similar to that of Mixture 4 (M4). Although Mixture 1 (M1) did not show the highest R/in., it was chosen for further studies because of its significantly lower density compared with that of the other mixtures.

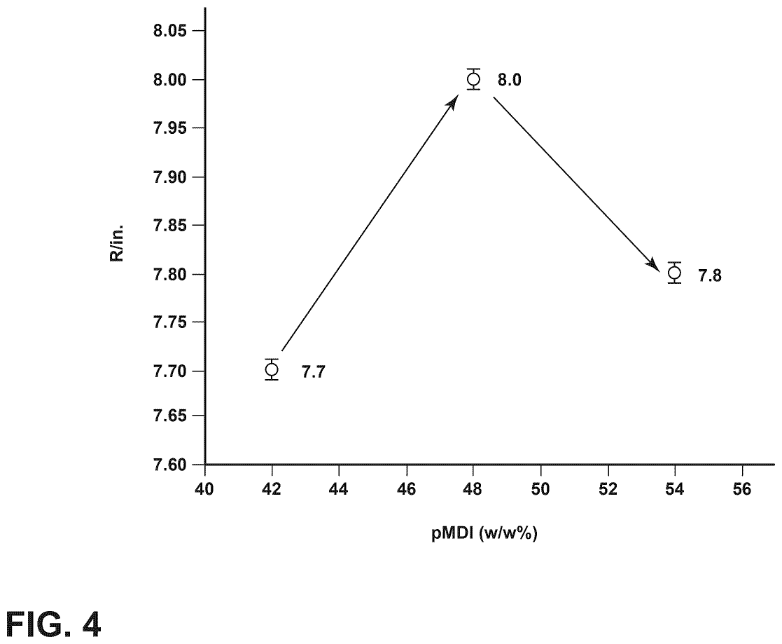

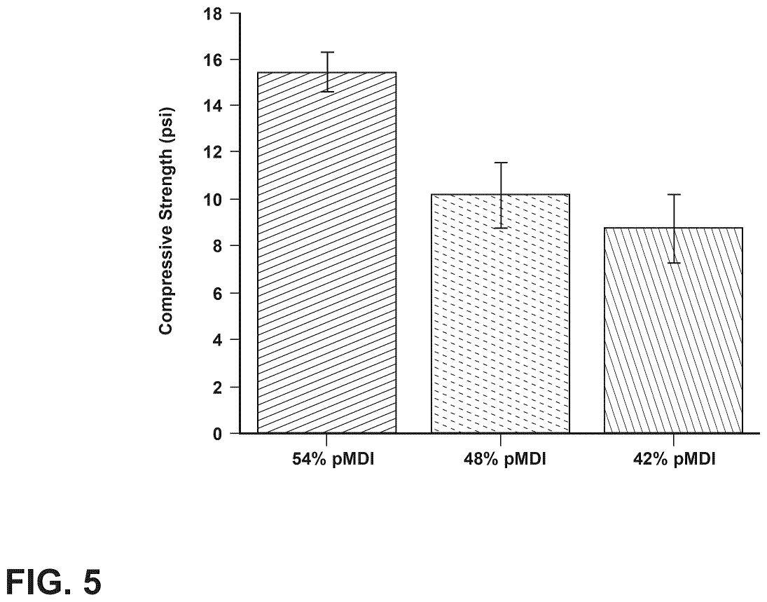

The effect of the pMDI content on the thermal insulation performance of the PIR foams was evaluated as shown in FIG. 4. The quantity of pMDI was reduced by 6% w/w (from 54% to 48%), resulting in a 3.4% improvement in the R/in. (from R/in. of 7.8. to R/in. of 8.0). However, a further reduction of pMDI (to 42% pMDI) led to a 4% decrease in R/in. Replicate studies showed consistent results, indicating the reproducibility of all samples. To further validate the results, the closed cell content of these compositions was analyzed using pycnometry. Consistent with earlier findings, samples with 42% pMDI exhibited 52% closed-cell content, representing a significant 29% reduction of closed-cell content compared with samples containing 48% pMDI, which show 78% closed-cell content. Both 54% and 48% pMDI offered less significant differences in closed-cell content of 89% and 78%, respectively. The compressive strength of the foams was also analyzed to investigate the effect of pMDI content on the mechanical properties of the foam samples. The corresponding results indicated that the pMDI content significantly affects the compressive strength of the foams as shown in FIG. 5. Specifically, an increase in the pMDI content led to higher compressive strength.

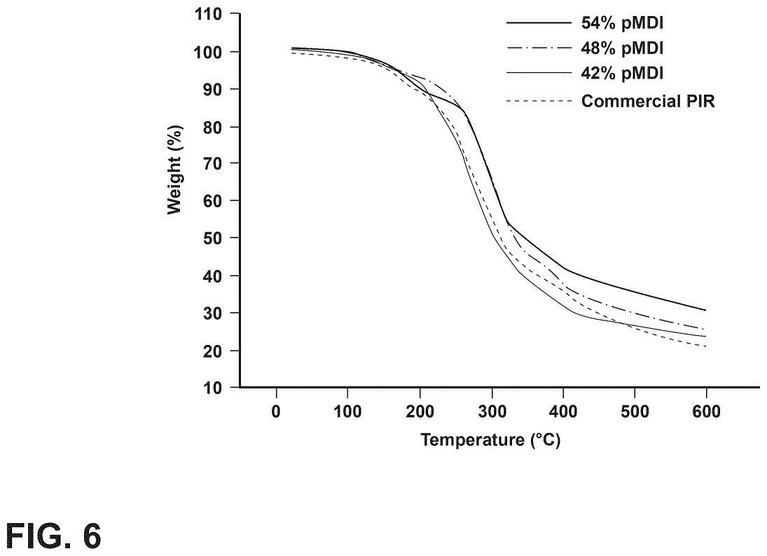

Thermal stability of the foam samples was assessed through TGA experiments that measured the change in mass of a foam sample as the temperature was gradually increased. The results indicated that the foam samples remain stable up to approximately 200° C. as shown in FIG. 6, beyond which decomposition begins. Char formation of the samples after TGA studies indicated the flame resistance of the material. The sample with 54% pMDI demonstrated a 31% char yield, whereas the samples with 48% and 42% pMDI showed char yields of 26% and 24%, respectively. The commercial PIR foam used as a comparative example exhibited the lowest char yield at 22%. Based on these findings, 48% pMDI was selected as the best formulation for further studies because of its promising R/in.

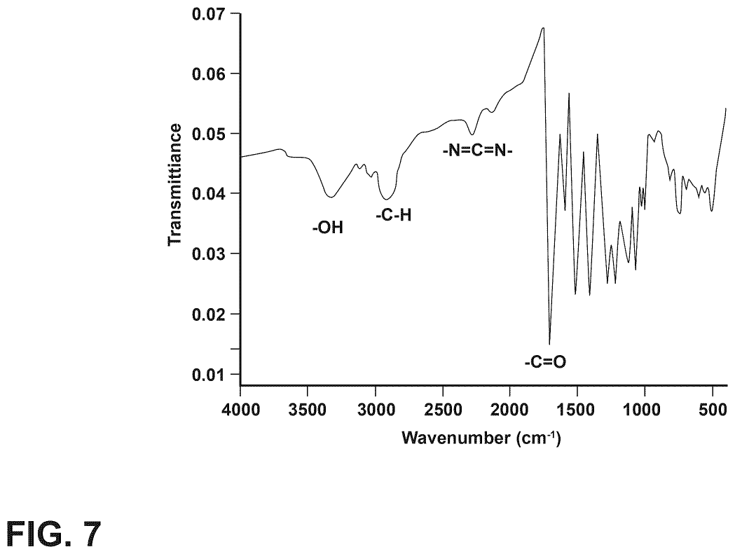

Fourier-Transform Infrared (FTIR) analysis was carried out to confirm the presence of functional groups typically present in PIR foams. (FTIR spectra were acquired using a Bruker INVENIO R equipped with an attenuated total reflectance (ATR) accessory. The FTIR spectra were collected over the range of 4000 to 400 cm⁻¹ with a resolution of 4 cm⁻¹, averaging 254 scans per sample at room temperature. Background spectra were subtracted from each sample spectrum to correct for atmospheric interference. Three replicates were conducted. The Solid+Gas and Radiation components were calculated using FTIR measurements, yielding a standard deviation of 0.06. The FTIR spectra shown in FIG. 7 revealed several characteristic absorption bands, including the polyurethane carbonyl (C═O) stretching vibration around 1710 cm⁻¹, the —N═C═N-stretching vibration near 2275 cm⁻¹, the hydroxyl (—OH) stretching vibration around 3300 cm⁻¹, and the C—H stretching vibration at approximately 2917 cm⁻¹.

A low permeable multilayer facer film that serves as a physical barrier against water vapor and gas molecules such as 02, CO₂, and N₂, was introduced to further test the thermal performance of the high-performance foams. The attached facer barrier can minimize outward diffusion of the blowing agent and inward diffusion of air. As a result, the addition of the facer barrier significantly improved the initial R/in. by approximately 4%, showing R/in. of 8.3 (sample size 2-3) compared with that of the control sample. Replication of the findings showed that the trials yielded similar outcomes. In addition to the initial R/in. values, facer barriers can play a significant role in reducing the thermal aging of PIR foams over time. Facer barriers minimize the diffusion of high thermal conductivity atmospheric gases and water vapor into the foam, while also preventing the escape of low thermal conductivity blowing agents. Initial testing has shown that PIR foams with facer barriers maintained a thermal resistance of up to R-7.4/in. after 180 days, while foam samples without facer films exhibited a decrease to R-6.7/in. over the same period.

To compare the present high-performance foams according to the embodiments disclosed herein with commercial foams, the effective thermal conductivity (k_{eff}) was decomposed from the gas, solid, and radiation contributions using the modeling tool ThermoPI. As shown in Table 4, the solid and radiation contributions in commercial PIR foams are about 3.9 and 1.6 mW·m⁻¹·K⁻¹, respectively. The gas contribution increased from 15.1 to 20.7 mW·m⁻¹·K⁻¹ after aging. The increase in thermal conductivity observed in commercial PIR foams may be attributed to low thermal conductivity blowing agents escaping out, while high thermal conductivity atmospheric gases and water vapor permeate into the foam, which causes the rise in thermal conductivity as time progresses. In the present embodiments, low-permeable facer films function as a physical barrier that prevent the diffusion of gases in and out of the foam, thereby minimizing the aging process of the foams over time. In comparison to commercial PIR foams, the foams according to the present embodiments have a higher radiation contribution but significantly lower solid and gas contributions. Because the present embodiments of high-performance foams are anisotropic, the solid and gas contributions cannot be decomposed. They together contribute k_{solid+gas}=15.2 and 19.4 mW·m⁻¹·K⁻¹ before and after aging, respectively, perpendicular to the long side of the cells. These solid and gas contributions are much smaller than those in commercial foams, which are about 20.6 and 24.6 mW·m⁻¹·K⁻¹ before and after aging, respectively.

TABLE 4
R-Values/in., Total Thermal Conductivities, and Decomposed Contributions for Present
Embodiments of High-Performance Foams and Conventional Commercial Foams

| | | Effective | | | Solid + | |
|---|---|---|---|---|---|---|
| | | k_{eff} | Solid | Gas | Gas | Radiation |
| | | (mW · m⁻¹ · | (mW · m⁻¹ · | (mW · m⁻¹ · | (mW · m⁻¹ · | (mW · m⁻¹ · |
| Foam | R/in. | K⁻¹) | K⁻¹) | K⁻¹) | K⁻¹) | K⁻¹) |
| Commercial PIR | 7.0 | 20.6 | 3.9 | 15.1 | 19.0 | 1.6 |
| (unaged) | | | | | | |
| Commercial PIR | 5.5 | 26.2 | 3.9 | 0.7 | 24.6 | 1.6 |
| (aged) | | | | | | |
| High-performance | 8.0 | 18.0 | —^{a} | — | 15.2 | 2.8 |
| foam (unaged) | | | | | | |
| High-performance | 6.5 | 22.2 | — | — | 19.4 | 2.8 |
| foam (aged) | | | | | | |
| High-performance | 8.3 | 17.3 | — | — | 14.5 | 2.8 |
| foam (unaged, with | | | | | | |
| facer) | | | | | | |
| High-performance | <6.7 | >21.4 | 8.0 | >10.6 | >18.4 | 2.8 |
| foam (unaged, if | | | | | | |
| isotropic) | | | | | | |

^{a}The “—” indicates that solid and gas contributions could not be decomposed due to their coupled nature in the anisotropic foams. The standard deviation for both Solid + Gas and Radiation components in the high-performance foams is consistently 0.06 across all measurements.

The superior properties of the present embodiments of high-performance foams compared with the properties of currently available commercial foams may be attributed to two key factors: (1) the choice of blowing agent; and (2) the anisotropic pore structure. Commercial foams typically use pentane as the blowing agent with water as an auxiliary component, which produces CO₂ as a byproduct. Pentane and CO₂ have thermal conductivities of 14.5 and 16.7 mW·m K⁻¹ at 24° C., respectively. In contrast, the present embodiments of high-performance foams utilize hydrofluoroolefin(s) as the blowing agent, which has a lower thermal conductivity of 10.6 mW·m⁻¹·K⁻¹ at 24° C. Additionally, by minimizing the water content in the formulation, the CO₂ concentration is low. Another distinguishing feature is the pore structure of the foam. While commercial foams have isotropic pores, the present embodiments of high-performance foams incorporate anisotropic pores that enhance the thermal insulation. If the present foams instead had isotropic pores, their initial R/in. would be less than 6.7, as predicted by the ThermoPI models.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A composition for fabricating a closed-cell polyisocyanurate (PIR) foam, the composition comprising:
approximately 20 to 45 wt. % of a polyol;
approximately 40 to 70 wt. % of a polymeric isocyanate;
approximately 0.1 to 1.0 wt. % of a trimerization catalyst;
approximately 0.1 to 1.0 wt. % of a polyurethane catalyst;
approximately 0.1 to 0.5 wt. % of a blowing catalyst;
approximately 0 to 4.0 wt. % of a silicone surfactant;
approximately 5 to 18 wt. % of a hydrofluoroolefin (HFO) blowing agent; and
approximately 0.2 to 0.5 wt. % of deionized (DI) water.

2. The composition of claim 1, wherein the polymeric isocyanate is selected from a group consisting of: i) polymeric methylene diphenyl diisocyanate (pMI); ii) polymeric toluene diisocyanate; and iii) polymeric isophorone diisocyanate.

3. The composition of claim 1, wherein the hydrofluoroolefin (HFO) blowing agent is selected from a group consisting of: i) cis-1,1,1,4,4,4-hexafluoro-2-butene; ii) trans-1,3,3,3-tetrafluoropropene; iii) trans-1-chloro-3,3,3-trifluoropropene; iv) trans-1-chloro-3,3,3-trifluoropropene; and v) a combination of one or more of i) through iv) with one or more of cyclopentane, isopentane, and n-pentane.

4. The composition of claim 1, wherein the polyol is selected from a group consisting of: i) an aromatic polyester polyol; ii) a polyether polyol; iii) an amine-functional polyol; iv) a bio-based polyol; v) a graft polyol; and vi) a combination of two or more of i) through v).

5. The composition of claim 1, wherein a content of the polymeric isocyanate is in a range of from approximately 40 to 55 wt. %.

6. The composition of claim 5, wherein the content of the polymeric isocyanate is in a range of from approximately 50 to 55 wt. %.

7. The composition of claim 5, wherein the content of the polymeric isocyanate is in a range of from approximately 48 to 52 wt. %.

8. The composition of claim 1, wherein a ratio of the polyol to the polymeric isocyanate is in a range of from approximately 0.3:1 to 0.8:1.

9. The composition of claim 1, further comprising:
approximately 3.0 to 4.5 wt. % of a flame retardant.

10. A method of fabricating a closed-cell polyisocyanurate foam, the method comprising the steps of:
preparing the composition of claim 1, wherein the step of preparing the composition includes:
mixing the polyol with the trimerization catalyst, the polyurethane catalyst, the blowing catalyst, the silicone surfactant, and the deionized water to form a first mixture;
subsequently mixing the hydrofluoroolefin blowing agent with the first mixture to obtain a second mixture; and
subsequently mixing the polymeric diisocyanate with the second mixture to obtain a third mixture;
transferring the third mixture onto a surface; and
controlling expansion of the third mixture in one direction while allowing free expansion of the third mixture in a direction generally perpendicular to the said one direction, the third mixture curing to form a closed-cell polyisocyanurate (PIR) foam having an anisotropic ratio of greater than approximately 1.5.

11. The method of claim 10, wherein the said one direction is generally perpendicular to the surface.

12. The method of claim 10, wherein the step of preparing the composition further comprises precooling the polyol prior to mixing the polyol with the trimerization catalyst, the polyurethane catalyst, the blowing catalyst, the silicone surfactant, and the deionized water to form the first mixture.

13. The method of claim 12, wherein the step of preparing the composition further comprises drying the polyol prior to pre-cooling the polyol.

14. The method of claim 10, wherein the step of preparing the composition further comprises pre-cooling the hydrofluoroolefin blowing agent prior to mixing the hydrofluoroolefin blowing agent with the first mixture to obtain the second mixture.

15. The method of claim 10, wherein the surface includes a multilayer facer, the multilayer facer comprising a metal layer and a polymer layer.

16. The method of claim 15, wherein the polymer layer of the multilayer facer faces the third mixture.

17. The method of claim 15, wherein the metal layer comprises a metal foil and the polymer layer comprises one or more of: a polyolefin, a polyester, a polyamide, polyethylene, polypropylene, polyethylene-vinyl alcohol copolymer, polyethylene terephthalate.

18. The method of claim 15, further comprising the step of sandwiching the third mixture between a pair of the multilayer facers.

19. The method of claim 10, wherein the closed-cell polyisocyanurate foam has an R/in value of at least 7.7.

20. The method of claim 10, wherein the closed-cell polyisocyanurate foam has a density less than 3.0 lb/ft³.

21. A closed-cell polyisocyanurate foam formed by the method of claim 10.
